(19) United States
(12) Patent Application Publication
(10) Pub. No.: US 2009/0088011 A1
(43) Pub. Date: Apr. 2, 2009

(54) Cable connector module

(76) Inventor: Yen-Chung Hsieh, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,512

(22) Filed: Oct. 2, 2007

(51) Int. Cl. H01R 29/00

(52) U.S. Cl. 439/171; 439/709

(57) ABSTRACT

A cable connector module includes a cable having a first end and a second end, a first plug connector assembled on the first end of the cable, and a second plug connector assembled on the second end of the cable. The second plug connector forms a second mating portion and a second connecting portion. The second mating portion and the second connecting portion offset 90° relative to each other in a horizontal plane, whereby a first mating socket connector and a second mating socket connector are arranged in low profile on a main board. This structure meets trend of miniature.

### BACKGROUND OF THE INVENTION

1. Field of the Invention

The present invention relates to a cable connector module, and particularly to a cable connector module with low profile structure.

2. Related Art

Electronic products have trend of low profile and multifunction. A main board assembled in an electronic product, as well as electronic components provided on the main board, is required to minimize size to meet the trend. Demand of reducing sizes of the main board and the electronic components, for example Input/Output connectors, increases difficulties in design and manufacturing.

It is well known that, a cable connector module is applied as a transfer line between systems. Such a cable connector module normally has a cable and connectors assembled on opposing ends of the cable. According to types of connectors, conventional cable connector modules are divided into several sorts: a plug connector and a socket connector respectively connected with opposing ends of a cable, both socket connectors respectively connected with opposing ends of a cable, both plug connectors respectively connected with opposing ends of a cable. The instant invention is mainly involved in a cable connector module which has both plug connectors respectively connected with opposing ends of a cable.

A cable connector module, which has both plug connectors respectively connected with opposing ends of a cable, is often used to transfer signals on the main board. This cable connector module mates with a mating connector to transmit signals in such a way that the plug connectors are parallel to each other or offset 90° relative to each other. As the plug connectors respectively connected with opposing ends of a cable offset 90° relative to each other, the plug connectors are arrayed in different planes. As a result, the overall height can not decrease because of orientations of the plug connectors.

### SUMMARY OF THE INVENTION

An object of the present invention is to provide a cable connector module which mates with mating connectors in low profile, and which provides 90° signal transmission in a horizontal plane, allowing mating connectors to be assembled on a main board in low profile, thereby meeting miniature tendency.

To achieve the above objects, the cable connector module according to the present invention comprises a cable having a first end and a second end, a first plug connector assembled on the first end of the cable, and a second plug connector assembled on the second end of the cable. The first plug connector includes a first insulative housing with a first circuit board therein. A plurality of first contact sheets is provided on an end of the first circuit board. The first insulative housing forms a first mating portion and a first connecting portion, the first mating portion corresponding to the first contact sheets for mating with a first mating socket connector. The second plug connector includes a second insulative housing with a second circuit board therein. A plurality of second contact sheets is provided on an end of the second circuit board. The second insulative housing forms a second mating portion and a second connecting portion, the second mating portion corresponding to the second contact sheets for mating with a second mating socket connector. The second mating portion and the second connecting portion offset 90° relative to each other in a horizontal plane, whereby the first mating socket connector and the second mating socket connector are arranged in low profile on a main board.

According to another aspect of the present invention, a plug connector for a cable connector module comprises an insulative housing including a mating portion for mating with a mating socket connector, and a connecting portion for connecting with a cable. The mating portion and the connecting portion offset 90° relative to each other in a horizontal plane, whereby mating socket connectors are arranged in low profile on a main board.

### BRIEF DESCRIPTION OF THE DRAWINGS

FIG. 1A is a perspective view of a cable connector module according to a first embodiment of the present invention.

FIG. 1B is a top view of the cable connector module of FIG. 1A.

FIG. 2 is a disassembled view of a second plug connector of the cable connector module of FIG. 1A.

FIG. 3 is an assembled view of FIG. 2.

FIG. 4A is a perspective view of a cable connector module according to a second embodiment of the present invention.

FIG. 4B is a top view of the cable connector module of FIG. 4A.

FIG. 5 is a disassembled view of a second plug connector of the cable connector module of FIG. 1A.

FIG. 6 is an assembled view of FIG. 5.

### DESCRIPTION OF THE PREFERRED EMBODIMENTS

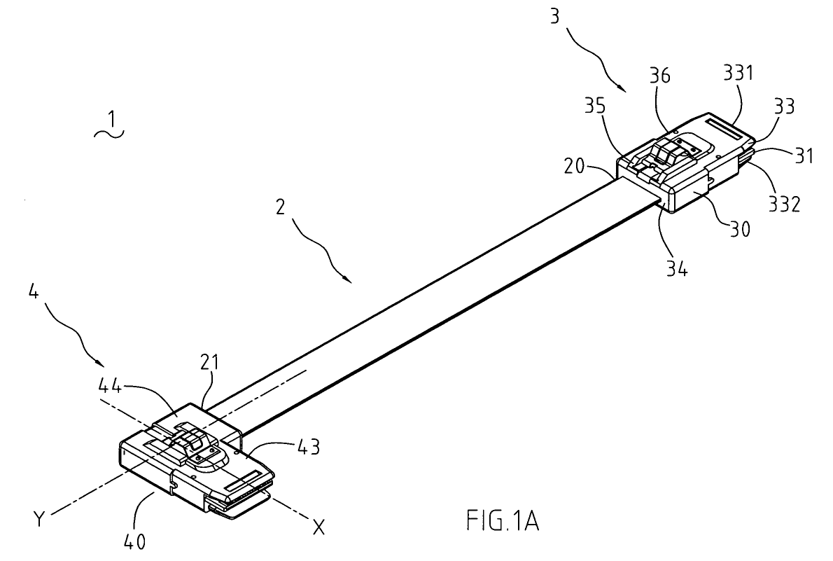

Referring to FIG. 1A, a cable connector module 1 in accordance with a first embodiment of the present invention comprises a cable 2, a first plug connector 3 and a second plug connector 4 respectively connected with opposing ends of the cable 2. The cable 2 is a flexible bus or a power wire, and has a first end 20 and a second end 21 opposing to each other.

The first plug connector 3 is assembled on the first end 20 of the cable 2, and includes a first insulative housing 30 with a first circuit board 31 therein. A plurality of first contact sheets (not shown) is provided on an end of the first circuit board 31 for electrically communicating with a first mating socket connector (not shown). The first insulative housing 30 forms a first mating portion 33, and a first connecting portion 34 for connecting with the first end 20 of the cable 2. The first mating portion 33 corresponds to the contact sheets for mating with the first mating socket connector (not shown). The first insulative housing 30 defines a first assembling groove 35, and a first button 36 is received in the first assembling groove 35 for facilitating mating operation. The first mating portion 33 of the first insulative housing 30 forms an upper bias surface 331 and a lower bias surface 332 which are spaced an appropriate distance apart from each other for cooperating with each other to engage with the a first mating section of the first mating socket connector (not shown).

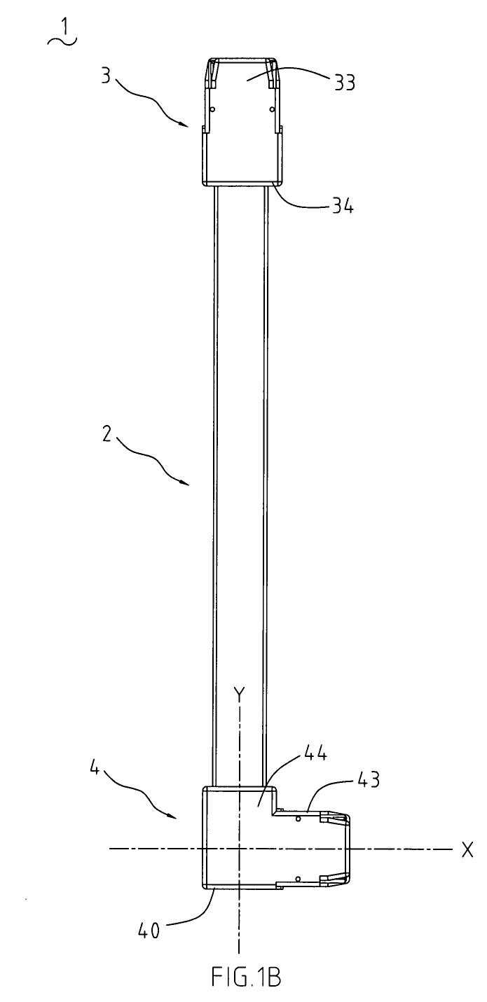

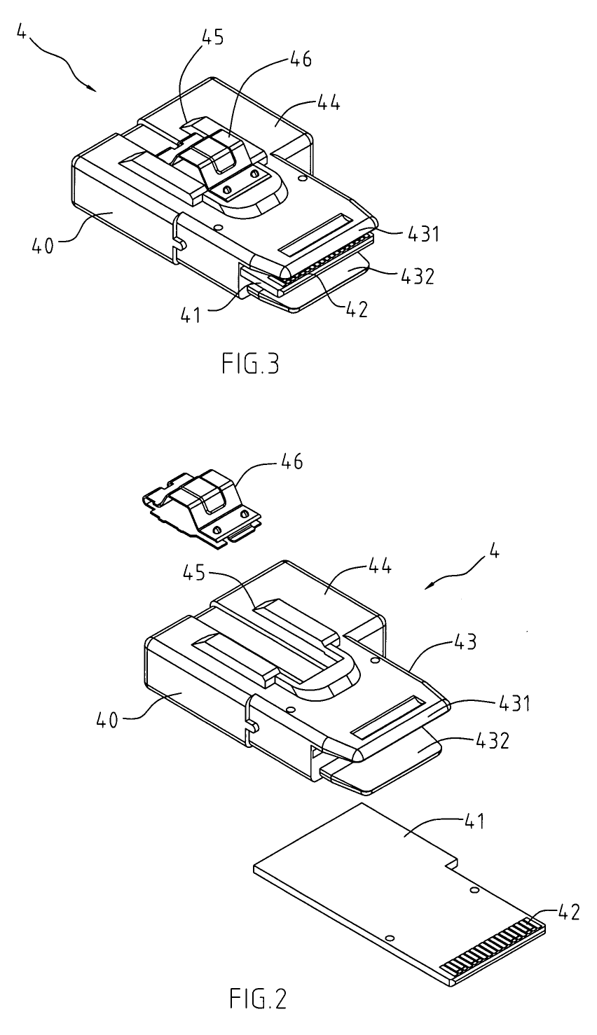

Referring to FIGS. 2 and 3, the second plug connector 4 is assembled on the second end 21 of the cable 2, and includes a second insulative housing 40 with a second circuit board 41 therein. A second assembling groove 45 is defined in a top surface of the second insulative housing 40. A second button 46 is mounted on the second assembling groove 45 for facilitating mating operation. A plurality of second contact sheets 42 are provided on an end of the second circuit board 41. The second insulative housing 40 forms a second mating portion 43 for corresponding to the second contact sheets 42, and a second connecting portion 44 for connecting with the second end 21 of the cable 2. The second mating portion 43 and the second connecting portion 44 offset 90° with respect to each other in a horizontal plane. As shown in FIG. 1B, an appropriate point of the cable 2, for example a distal end of the cable 2, serving as a center, the second insulative housing 40 has an X axis portion and a Y axis portion respectively extending along X axis and Y axis. The X axis portion is located at right of the Y axis portion. The second mating portion 43 is formed on the X axis portion, and the second connecting portion 44 is formed on the Y axis portion. The second mating portion 43 includes an upper latch surface 431 and a lower latch surface 432 which are spaced an appropriate distance apart from each other for cooperating with each other to engage with a second mating section of the second mating socket connector.

The second mating portion 43 of the second insulative housing 40 offsets 90° relative to the second connecting portion 44 in a horizontal plane. Thus, the first and the second mating socket connectors are arranged in low profile on a main board, meeting tendency of miniature.

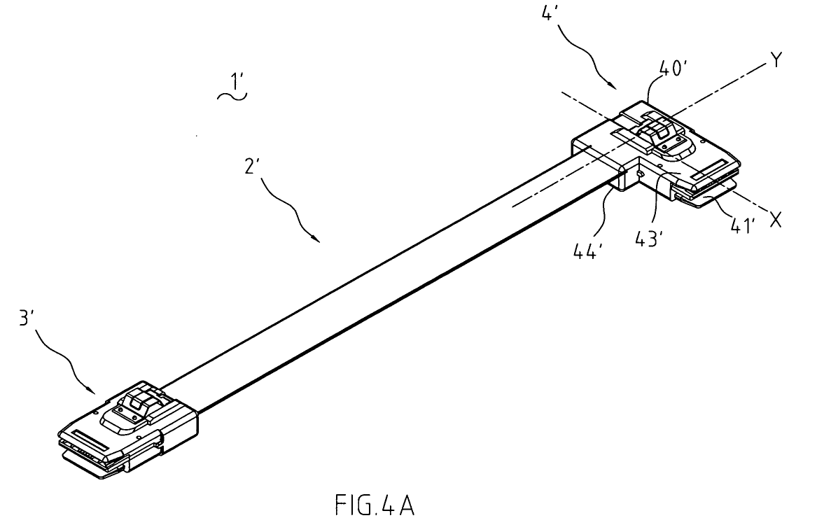

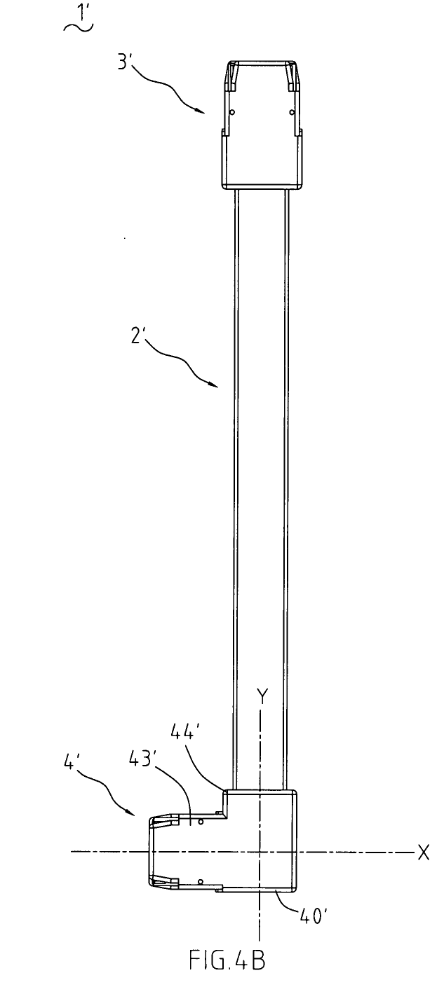

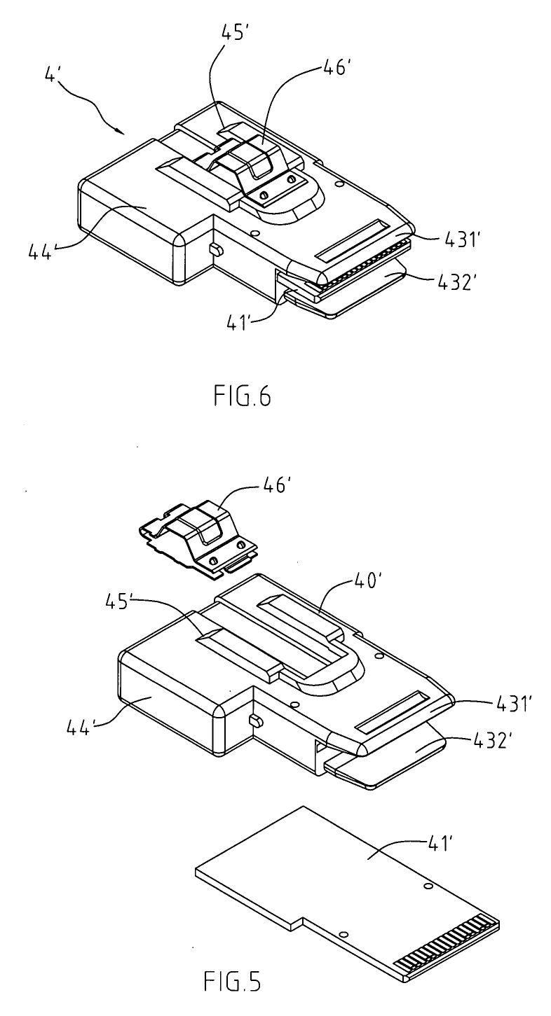

FIGS. 4 to 6 illustrate a cable connector module 1′ according to a second embodiment of the present invention. Similarly, the cable connector module 1′ comprises a cable 2′, a first plug connector 3′, a second plug connector 4′ respectively connected with opposing ends of the cable 2′. The second plug connector 4′ includes a second insulative housing 40′ with a second circuit board 41′ received therein. A second assembling groove 45′ is defined in the second insulative housing 40, and receives a second button 46′. The second mating portion 43′ includes an upper latch surface 431′ and a lower latch surface 432′ which are spaced an appropriate distance apart from each other for cooperating with each other to engage with a second mating section of the second mating plug connector (not shown).

As shown in FIG. 4B, an appropriate point of the cable 2′, for example a distal end of the cable 2′, serving as a center, the second insulative housing 40′ has an X axis portion and a Y axis portion respectively extending along X axis and Y axis. The X axis portion is located at left of the Y axis portion. The second mating portion 43′ is formed on the X axis portion, and the second connecting portion 44′ is formed on the Y axis portion. The second mating portion 43′ and the second connecting portion 44′ offset 90° relative to each other in a horizontal plane. In this way, the first and the second mating socket connectors are arranged in low profile on a main board, meeting tendency of miniature.

It is understood that the invention may be embodied in other forms without departing from the spirit thereof. Thus, the present examples and embodiments are to be considered in all respects as illustrative and not restrictive, and the invention is not to be limited to the details given herein.

1. A cable connector module comprising:
a cable having a first end and a second end;
a first plug connector assembled on the first end of the cable, and including a first insulative housing with a first circuit board therein, a plurality of first contact pads being provided on an end of the first circuit board, the first insulative housing forming a first mating portion and a first connecting portion, the first mating portion corresponding to the first contact pads for mating with a first mating socket connector, the first mating portion and the first connecting portion being in longitudinal alignment in a plane; and
a second plug connector assembled on the second end of the cable, and including a second insulative housing with a second circuit board therein, a plurality of second contact pads being provided on an end of the second circuit board, the second insulative housing forming a second mating portion and a second connecting portion, the second mating portion corresponding to the second contact pads for mating with a second mating socket connector;
wherein the second mating portion and the second connecting portion are offset 90° relative to each other and in a common plane with the first mating portion and the first connecting portion of the first plug connector, the second connecting portion being oriented for mating with a corresponding receptacle in the common plane, whereby the first mating portion and the second mating portion are offset 90° relative to each other, and the corresponding first mating socket connector and the second mating socket connector are arranged in low profile on a main circuit board.

2. The cable connector module as recited in claim 1, wherein the second insulative housing has an X axis portion and a Y axis portion, the Y axis portion extending along a longitudinal axis of the cable and the X axis portion being orthogonal to the Y axis portion and defining an axis of the second mating portion of the second insulative housing, the second connecting portion of the second insulative housing having an axis defined by the Y axis portion.

3. (canceled)

4. The cable connector module as recited in claim 1, wherein the first insulative housing defines a first assembling groove, and a first button is mounted in the first assembling groove for facilitating mating operation, and wherein the second insulative housing defines a second assembling groove, and a second button is mounted in the second assembling groove for facilitating mating operation.

5. The cable connector module as recited in claim 1, wherein the first mating portion of the first insulative housing forms an upper bias surface and a lower bias surface which are spaced an appropriate distance apart from each other for cooperating with each other to engage with a first mating section of the first mating socket connector.

6. The cable connector module as recited in claim 1, wherein the second mating portion includes an upper latch surface and a lower latch surface which are spaced an appropriate distance apart from each other for cooperating with each other to engage with a second mating section of the second mating socket connector.

7. The cable connector module as recited in claim 1, wherein the cable is a flexible bus or a flexible power wire.

8-10. (canceled)
